(19) United States
(12) Patent Application Publication
(10) Pub. No.: US 2026/0022560 A1
(43) Pub. Date: Jan. 22, 2026

(54) ELECTRICALLY GROUNDING METAL ROOFING SHINGLES WITH PHOTOVOLTAIC SYSTEMS

(71) Applicant: GAF Energy LLC, Parsippany, NJ (US)

(72) Inventors: Thierry Nguyen, San Francisco, CA (US); Gary Rossi, San Francisco, CA (US); Peter Wilke, San Jose, CA (US); David Meakin, Santa Clara, CA (US); Anshul Gaur, San Francisco, CA (US); Brian West, San Francisco, CA (US)

(21) Appl. No.: 19/273,675

(22) Filed: Jul. 18, 2025

Related U.S. Application Data
(60) Provisional application No. 63/674,050, filed on Jul. 22, 2024.

(51) Int. Cl. E04D 1/18; E04D 1/00; E04D 1/34; F16B 15/06; F16B 43/00; H02S 20/23

(52) U.S. Cl. CPC E04D 1/18; E04D 1/2918; E04D 1/2942; E04D 1/34; F16B 15/06; F16B 43/00; H02S 20/23; E04D 2001/3423; E04D 2001/3461; E04D 2001/3494

(57) ABSTRACT

A roofing system, including at least a first, second, and third metal roofing shingle installed on a roof deck adjacent to a plurality of photovoltaic modules, the first and second metal roofing shingles installed in a first row on the roof deck, the third metal roofing shingle installed in a second row on the roof deck, each of the metal roofing shingles including a metal layer and a cover layer, the metal layer including a conductive metal, the cover layer overlaying a portion of the metal layer and exposing at least one side lap of the metal layer, the side lap of the metal layer of the second metal roofing shingle overlaying and in electrical contact with the side lap of the metal layer of the first metal roofing shingle, to form a first grounding path, and the third metal roofing shingle in electrical contact with the first metal roofing shingle, to form a second grounding path.

### CROSS-REFERENCE TO RELATED APPLICATION

This application is a Section 111(a) application relating to and claiming the benefit of commonly owned, co-pending U.S. Provisional Patent Application Ser. No. 63/674,050, filed Jul. 22, 2024, entitled “SYSTEMS AND METHODS OF ELECTRICALLY GROUNDING METAL ROOFING SHINGLES WITH PHOTOVOLTAIC SYSTEMS,” the contents of which is incorporated herein by reference in its entirety.

### FIELD

The present invention relates to roofing systems, and, more particularly, systems and methods for electrically grounding metal roofing shingles as part of a roofing systems including photovoltaic modules.

### BACKGROUND

In known roofing systems, photovoltaic modules, which include at least one solar cell, and metal roofing shingles are installed on a roof deck.

### SUMMARY

The Summary is a high-level overview of various aspects of the invention, and introduces some concepts that are further described in the Detailed Description below. The Summary is not intended to identify key or essential features of the disclosed subject matter, and also is not intended to be used in isolation to determine the scope of the disclosed subject matter. Instead, the disclosed subject matter should be understood by reference to appropriate portions of the Specification and drawings.

In some embodiments, a roofing system includes a roof deck; a plurality of photovoltaic modules installed on the roof deck, wherein each of the photovoltaic modules includes at least one solar cell; and a plurality of metal roofing shingles installed on the roof deck adjacent to the plurality of photovoltaic modules, wherein the plurality of metal roofing shingles includes at least a first metal roofing shingle, a second metal roofing shingle, and a third metal roofing shingle, wherein the first metal roofing shingle and the second metal roofing shingle are installed in a first row on the roof deck, wherein the third metal roofing shingle is installed in a second row on the roof deck, wherein the second row is adjacent the first row on the roof deck, wherein each of the metal roofing shingles includes a metal layer, wherein the metal layer includes a conductive metal, wherein the metal layer includes a side lap, wherein the side lap of the metal layer of the second metal roofing shingle overlays and is in electrical contact with the side lap of the metal layer of the first metal roofing shingle, to form a first grounding path, wherein the third metal roofing shingle is in electrical contact with the first metal roofing shingle, to form a second grounding path.

In some embodiments, each of the metal roofing shingles includes a cover layer, wherein the cover layer overlays at least a portion of the metal layer, and wherein the side lap is between an end of the metal layer and an end of the cover layer. In some embodiments, the first grounding path and the second grounding path are in electrical connection.

In some embodiments, the system further includes a plurality of fasteners, wherein the plurality of fasteners includes at least a first fastener and a second fastener, wherein the first fastener penetrates each of: the metal layer of the first metal roofing shingle, the metal layer of the second metal roofing shingle, and the roof deck, wherein the second fastener penetrates each of the metal layer of the first metal roofing shingle, the metal layer of the third metal roofing shingle, and the roof deck.

In some embodiments, the system further includes a plurality washers, wherein each of the washers includes a through hole, wherein the plurality of washers includes at least a first washer and a second washer, wherein the first washer is positioned between: the metal layer of the first metal roofing shingle, and the metal layer of the second metal roofing shingle, wherein the first fastener extends through the through hole of the first washer, wherein the second washer is positioned between: the metal layer of the first metal roofing shingle, and the metal layer of the third metal roofing shingle, wherein the second fastener extends through the through hole of the second washer.

In some embodiments, each of the washers includes corrugations, wherein the corrugations of the first washer are in contact with the metal layer of the first metal roofing shingle and the metal layer of the second metal roofing shingle, wherein the corrugations of the second washer are in contact with the metal layer of the first metal roofing shingle and the metal layer of the third metal roofing shingle.

In some embodiments, the system further includes a plurality of fasteners, wherein the plurality of fasteners includes at least a first fastener, a second fastener, and a third fastener, wherein each of the fasteners includes a fastener head, a fastener shaft extending from the fastener head, and at least one fastener barb extending from the fastener head, wherein the fastener shaft of the first fastener penetrates each of: the metal layer of the first metal roofing shingle, the metal layer of the second metal roofing shingle, and the roof deck, wherein the at least one fastener barb of the first fastener penetrates: the metal layer of the first metal roofing shingle, and the metal layer of the second metal roofing shingle, wherein the fastener shaft of the second fastener penetrates each of: the metal layer of the first metal roofing shingle, the metal layer of the third metal roofing shingle, and the roof deck, wherein the at least one fastener barb of the second fastener penetrates: the metal layer of the first metal roofing shingle, and the metal layer of the third metal roofing shingle.

In some embodiments, the system further includes a plurality of fasteners, wherein the plurality of fasteners includes at least a first fastener, a second fastener, and a third fastener, wherein each of the fasteners includes a fastener head, a fastener shaft extending from the fastener head, and at least one fastener barb extending from the fastener shaft, wherein the fastener shaft of the first fastener penetrates each of: the metal layer of the first metal roofing shingle, the metal layer of the second metal roofing shingle, and the roof deck, wherein the at least one fastener barb of the first fastener retains the metal layer of the first metal roofing shingle in contact with the metal layer of the second metal roofing shingle, wherein the fastener shaft of the second fastener penetrates each of: the metal layer of the first metal roofing shingle, the metal layer of the third metal roofing shingle, and the roof deck, wherein the at least one fastener barb of the second fastener retains the metal layer of the first metal roofing shingle in contact with the metal layer of the third metal roofing shingle.

In some embodiments, the system further includes a plurality of fasteners, wherein the plurality of fasteners includes at least a first fastener, wherein each of the metal roofing shingles comprise at least one cooperating feature, wherein the first fastener extends through: the at least one cooperating feature of the first metal roofing shingle, and the at least one cooperating feature of the second metal roofing shingle, so that the at least one cooperating feature of the first metal roofing shingle is engaged with the at least one cooperating feature of the second metal roofing shingle.

In some embodiments, each of the metal roofing shingles includes an adhesive, the roofing system includes a fastener, wherein the fastener penetrates the adhesive of at least one of the first metal roofing shingle or the second metal roofing shingle.

In some embodiments, a roofing system includes a roof deck; a plurality of photovoltaic modules installed on the roof deck, wherein each of the photovoltaic modules includes at least one solar cell; a plurality of metal roofing shingles installed on the roof deck adjacent to the plurality of photovoltaic modules, wherein the plurality of metal roofing shingles includes at least a first metal roofing shingle and a second metal roofing shingle, wherein the first metal roofing shingle is installed in a first row on the roof deck, wherein the second metal roofing shingle is installed in a second row on the roof deck, wherein the second row is adjacent the first row on the roof deck, wherein each of the metal roofing shingles includes a metal layer, wherein the metal layer includes a conductive metal material, wherein the metal layer includes an upper bend and a lower bend; and a plurality of clips, wherein the plurality of clips includes at least a first clip, wherein the first clip is in electrical contact with each of: the upper bend of the first metal roofing shingle, and the lower bend of the second metal roofing shingle, to form a first grounding path.

In some embodiments, each of the clips includes a first protrusion, wherein the first protrusion of the first clip is in contact with the upper bend of the first metal roofing shingle, and a second protrusion, wherein the second protrusion of the first clip is in contact with the lower bend of the second metal roofing shingle.

In some embodiments, the system further includes a plurality of fasteners, wherein the plurality of fasteners includes at least a first fastener and a second fastener, wherein the first fastener penetrates the first metal roofing shingle and the roof deck, wherein the second fastener penetrates the second metal roofing shingle and the roof deck.

In some embodiments, the plurality of metal roofing shingles further includes at least a third metal roofing shingle, wherein the plurality of clips further includes a second clip, wherein the roofing system further includes a connector, wherein the third metal roofing shingle is installed in the first row of the roof deck, adjacent to the first metal roofing shingle, wherein the second clip contacts the upper bend of the third metal roofing shingle, to form a second grounding path, wherein the connector is in connection with the first clip and the second clip, to form a third grounding path.

In some embodiments, the system further includes a plurality of fasteners, wherein the plurality of fasteners includes at least a first fastener and a second fastener, wherein the first fastener penetrates the upper bend of the first metal roofing shingle and the roof deck, wherein the second fastener penetrates the upper bend of the second metal roofing shingle and the roof deck.

In some embodiments, a method includes obtaining a photovoltaic module and a plurality of metal roofing shingles, wherein the photovoltaic module includes at least one solar cell, wherein the plurality of metal roofing shingles includes at least a first metal roofing shingle, a second metal roofing shingle, and a third metal roofing shingle, wherein each of the metal roofing shingles includes a metal layer, wherein the metal layer includes a conductive metal material, wherein the metal layer includes a side lap; installing the photovoltaic module on a roof deck; installing the first metal roofing shingle in a first row on the roof deck, adjacent to the photovoltaic module; installing the second metal roofing shingle in the first row on the roof deck, adjacent to the first metal roofing shingle, wherein the side lap of the metal layer of the second metal roofing shingle overlays and is in electrical contact with the side lap of the metal layer of the first metal roofing shingle, to form a first grounding path; and installing the third metal roofing shingle in a second row on the roof deck, wherein the second row is adjacent the first row on the roof deck, wherein the third metal roofing shingle is in electrical contact with the first metal roofing shingle, to form a second grounding path.

In some embodiments, the first grounding path is in electrical connection with the second grounding path.

In some embodiments, the installing the first metal roofing shingle includes penetrating, with a first fastener, each of: the metal layer of the first metal roofing shingle, the metal layer of the second metal roofing shingle, and the roof deck.

In some embodiments, the method further includes obtaining a washer, wherein the washer includes a through hole, wherein the installing the second metal roofing shingle includes positioning a washer between the metal layer of the first metal roofing shingle, and the metal layer of the second metal roofing shingle; and disposing a fastener through each of: the metal layer of the first metal roofing shingle, the metal layer of the second metal roofing shingle, the through hole of the washer, and the roof deck.

In some embodiments, the method further includes obtaining a fastener, wherein the fastener includes a fastener head, a fastener shaft extending from the fastener head, and at least one fastener barb extending from the fastener head; wherein the installing the second metal roofing shingle includes penetrating, with the fastener shaft of the fastener, each of: the metal layer of the first metal roofing shingle, the metal layer of the second metal roofing shingle, and the roof deck; and penetrating, with the at least one fastener barb of the fastener, each of: the metal layer of the first metal roofing shingle, and the metal layer of the second metal roofing shingle.

In some embodiments, the method further includes obtaining a fastener, wherein the fastener includes a fastener head, a fastener shaft extending from the fastener head, and at least one fastener barb extending from the fastener shaft; wherein the installing the second metal roofing shingle includes penetrating, with the fastener shaft of the fastener, each of: the metal layer of the first metal roofing shingle, the metal layer of the second metal roofing shingle, and the roof deck; and urging toward one another, with the at least one fastener barb of the fastener, each of: the metal layer of the first metal roofing shingle, and the metal layer of the second metal roofing shingle.

In some embodiments, the method further includes obtaining a fastener, wherein the fastener includes a fastener head, a fastener shaft extending from the fastener head, and at least one fastener barb extending from the fastener shaft; wherein the installing the second metal roofing shingle includes penetrating, with the fastener shaft of the fastener, each of: the metal layer of the first metal roofing shingle, the metal layer of the second metal roofing shingle, and the roof deck; and urging toward one another, with the at least one fastener barb of the fastener, each of: the metal layer of the first metal roofing shingle, and the metal layer of the second metal roofing shingle.

In some embodiments, each of the metal roofing shingles includes at least one cooperating feature, wherein the installing the second metal roofing shingle includes installing a fastener through each of: the at least one cooperating feature of the first metal roofing shingle, and the at least one cooperating feature of the second metal roofing shingle, so that the at least one cooperating feature of the first metal roofing shingle is engaged with a corresponding one of the at least one cooperating feature of the second metal roofing shingle.

In some embodiments, a method includes obtaining a photovoltaic module, a plurality of metal roofing shingles, and a plurality of clips, wherein the photovoltaic module includes at least one solar cell; wherein the plurality of metal roofing shingles includes at least a first metal roofing shingle and a second metal roofing shingle, wherein each of the metal roofing shingles includes a metal layer, wherein the metal layer includes a conductive metal, wherein the metal layer includes an upper bend and a lower bend, wherein the plurality of clips includes at least a first clip; installing the photovoltaic module on a roof deck; installing the first metal roofing shingle in a first row on the roof deck, adjacent to the photovoltaic module; installing the first clip in the upper bend of the first metal roofing shingle, such that the first clip is in electrical contact with the upper bend, to form a first grounding path; and installing the second metal roofing shingle in a second row on the roof deck, such that the first clip is in electrical contact with the lower bend of the second metal roofing shingle, to form a second grounding path, wherein the second row is adjacent the first row on the roof deck.

In some embodiments, each of the clips includes a first protrusion, and a second protrusion, wherein the installing the first clip includes installing the first clip in the upper bend of the first metal roofing shingle such that the first protrusion of the first clip is in electrical contact with the upper bend of the first metal roofing shingle, wherein the installing the second metal roofing shingle includes installing the second metal roofing shingle such that the lower bend of the second metal roofing shingle is in electrical contact with the second protrusion.

In some embodiments, the installing the first metal roofing shingle further includes penetrating each of the first metal roofing shingle and the roof deck with a first fastener, wherein the installing the second metal roofing shingle further includes penetrating each of the second metal roofing shingle and the roof deck with a second fastener.

In some embodiments, the plurality of metal roofing shingles further includes at least a third metal roofing shingle, wherein the plurality of clips further includes a second clip, wherein the method further includes obtaining a connector; installing the third metal roofing shingle in the first row of the roof deck, adjacent the first metal roofing shingle, to form a third grounding path; installing the second clip in the upper bend of the third metal roofing shingle, to form a fourth grounding path; and installing the connector to connect the first clip in the first metal roofing shingle and the second clip in the third metal roofing shingle, to form a fifth grounding path.

In some embodiments, the method further includes obtaining a plurality of fasteners, wherein the plurality of fasteners includes at least a first fastener and a second fastener, wherein the installing the first metal roofing shingle further includes penetrating, with the first fastener, the upper bend of the first metal roofing shingle and the roof deck, wherein the installing the second metal roofing shingle further includes penetrating, with the second fastener, the upper bend of the second metal roofing shingle and the roof deck.

### BRIEF DESCRIPTION OF THE DRAWINGS

This section refers to the drawings that form a part of this disclosure, and which illustrate some of the embodiments of structure, materials, and/or methods of the present invention described herein.

FIG. 1 is a schematic top view of a roofing system including a plurality of photovoltaic modules as well as a plurality of metal roofing shingles installed on a roof deck, in accordance with some embodiments of the invention.

FIG. 2 is a schematic top view of one of the metal roofing shingles of FIG. 1, in accordance with some embodiments of the invention.

FIG. 3 is a schematic cross-sectional view of the metal roofing shingle taken along line Ill-Ill in FIG. 2, in accordance with some embodiments of the invention.

FIG. 4 is a schematic top view of a washer employed by a roofing system, in accordance with some embodiments of the invention.

FIG. 5 is a schematic side view of the washer of FIG. 4, in accordance with some embodiments of the invention.

FIG. 6 is a schematic side view of a fastener employed by a roofing system, in accordance with some embodiment of the invention.

FIG. 7 is a schematic side view of a fastener employed by a roofing system, in accordance with some embodiment of the invention.

FIG. 8 is a schematic cross-sectional view of portions of the metal roofing shingles, in accordance with some embodiments of the invention.

FIG. 9 is a schematic top view of the roofing system including the plurality of photovoltaic modules as well as the plurality of metal roofing shingles installed on the roof deck, in accordance with some embodiments of the invention.

FIG. 10 is a schematic cross-sectional view of the metal roofing shingle taken along line X-X in FIG. 9, in accordance with some embodiments of the invention.

FIG. 11 is a schematic cross-sectional view of a clip employed by a roofing system, in accordance with some embodiments of the invention.

FIG. 12 is a schematic top view of a connector, in accordance with some embodiments of the invention.

FIG. 13 is a schematic side view of the connector of FIG. 12, in accordance with some embodiments of the invention.

FIG. 14 is a schematic top view of two clips 700 connected by connector 800, in accordance with some embodiments of the invention.

### DETAILED DESCRIPTION

In addition to the benefits and improvements that the Specification discloses, other objects and advantages that the Specification provides will become apparent from the following description taken in conjunction with the accompanying figures. Although the description discloses and describes detailed embodiments of the present disclosure, the disclosed embodiments are merely illustrative of the disclosure that may be embodied in various forms. In addition, each of the examples given regarding the various embodiments of the disclosure are intended to be illustrative, and not restrictive.

As used herein, a “steep slope” roof or roof deck is a roof or roof deck that has a pitch of Y/X, where Y and X are in a ratio of 4:12 to 20:12, where Y corresponds to the “rise” of the roof or roof deck, and where X corresponds to the “run” of the roof or roof deck.

As used herein, a “sloped” roof or roof deck is a roof or roof deck that has a pitch greater than zero (the roof or roof deck is not flat), but the pitch is less than that of a steep slope roof or roof deck.

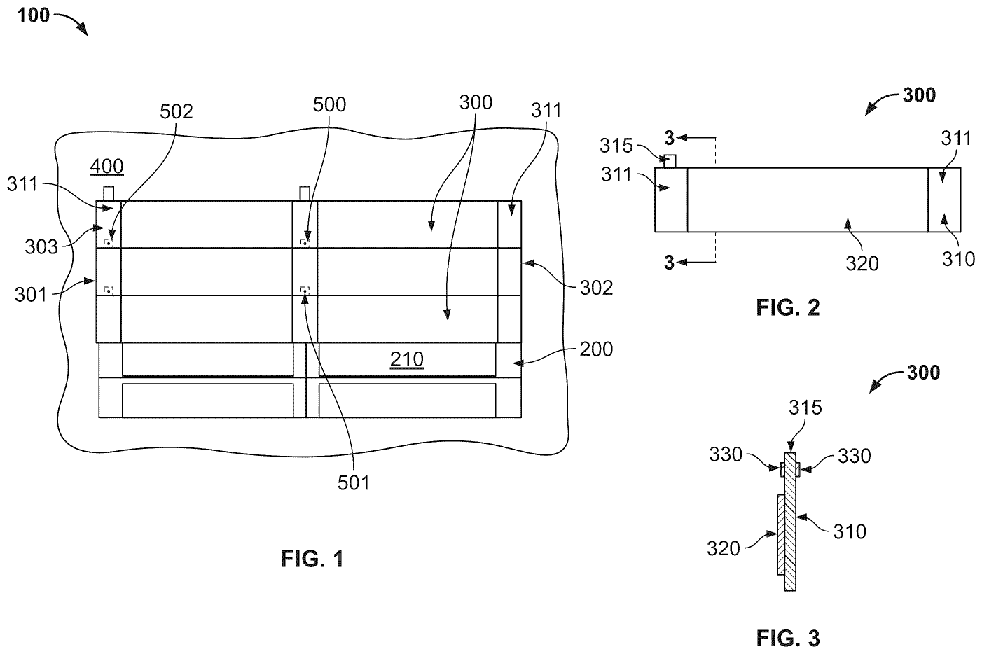

With reference to the drawings, FIG. 1 is a schematic top view of a roofing system 100 including a plurality of photovoltaic modules 200 as well as a plurality of metal roofing shingles 300 installed on a roof deck 400 by a plurality of fasteners 500; FIG. 2 is a schematic top view of one of the metal roofing shingles 300 of FIG. 1; and FIG. 3 is a schematic cross-sectional view of the metal roofing shingle 300 taken along line III-III in FIG. 2, in accordance with some embodiments of the invention. In some embodiments, as FIG. 1 shows, the plurality of metal roofing shingles 300 is installed on the roof deck 400 adjacent to the plurality of photovoltaic modules 200. Although FIG. 1 shows the photovoltaic modules 200 and the metal roofing shingles 300 installed in rectangular arrays, in some embodiments, either or both of the photovoltaic modules 200 and/or the metal roofing shingles 300 are installed in an offset/staggered configuration, in which joints or seams between adjacent photovoltaic modules 200 and/or metal roofing shingles 300 in a same row on the roof deck 400 are not aligned with the joints or seams between adjacent photovoltaic modules 200 and/or metal roofing shingles 300 in a row that is directly above or directly below that row on the roof deck 400.

In some embodiments, FIG. 1 shows, each of the photovoltaic modules 200 includes at least one solar cell 210. In some embodiments, one or more of the photovoltaic modules 200 includes a structure, composition, component, and/or function, except as otherwise described or shown herein, similar to those of one or more embodiments of the photovoltaic modules and photovoltaic shingles as disclosed, shown, and/or described in any or all of: U.S. application Ser. No. 17/831,307, filed Jun. 2, 2022, titled “Roofing Module System,” and published under U.S. Patent Application Publication No. 2022-0393637 on Dec. 8, 2022; U.S. application Ser. No. 18/169,718, filed Feb. 15, 2023, titled “Roofing Module System,” and published under U.S. Patent Application Publication No. 2023-0203815 on Jun. 29, 2023; U.S. Pat. No. 11,870,227, issued Jan. 9, 2024, entitled “Building Integrated Photovoltaic System,” owned by GAF Energy LLC,; and/or U.S. Pat. No. 11,251,744 to Bunea et al., issued Feb. 15, 2022, titled “Photovoltaic Shingles and Methods of Installing Same”; and the disclosures of each of which are incorporated by reference herein in their entireties, with certain different and/or additional features as described herein.

As FIG. 1 shows, in some embodiments, the plurality of metal roofing shingles 300. In some embodiments, one or more of the metal roofing shingles 300 includes a structure, composition, component, and/or function, except as otherwise described or shown herein, similar to those of one or more embodiments of the metal roofing shingles and/or panels as disclosed, shown, and/or described in either or both of U.S. Pat. No. 11,603,660 to Anderson et al., issued Mar. 14, 2023, titled “Steep Slope Roofing Panel System and Method,” and/or U.S. Pat. No. 11,566,426 to Boss et al., issued Jan. 31, 2023, titled “Roofing Panels with Water Shedding Features,” and the disclosures of each of which are incorporated by reference herein in their entireties, with certain different and/or additional features as described herein.

In some embodiments, the plurality of metal roofing shingles 300 includes at least a first metal roofing shingle 301, a second metal roofing shingle 302, and a third metal roofing shingle 303. It is understood, however, that in some embodiments, the roofing system 100 includes a greater number or a lesser number of photovoltaic modules 200 and/or metal roofing shingles 300 than FIG. 1 shows and/or as described herein. In some embodiments, as FIG. 1 shows, the first metal roofing shingle 301 and the second metal roofing shingle 302 are installed in a first row on the roof deck 400. In some embodiments, as FIG. 1 shows, the third metal roofing shingle 303 is installed in a second row on the roof deck 400. In some embodiments, the second row is adjacent the first row on the roof deck 400. In some embodiments, adjacent rows are rows that are vertically adjacent to one another on the roof deck 400, such that one row is immediately above or below another row on the roof deck 400.

In some embodiments, as FIGS. 2 and 3 show, the metal roofing shingles 300 include a metal layer 310. In some embodiment, each of the metal roofing shingles 300 includes a cover layer 320. In some embodiments, the metal layer 310 includes a conductive metal. In some embodiments, the cover layer 320 overlays a portion of the metal layer 310, thereby exposing at least one side lap 311 of the metal layer 310. In some embodiments, the cover layer 320 overlays a portion of the metal layer 310, thereby exposing two side laps 311 of the metal layer 310. In some embodiments, the cover layer 320 is electrically non-conductive. In some embodiments, the cover layer 320 includes one or more of a polymer, a paint, or a non-electrically conductive metal and/or other material.

As FIG. 1 shows, in some embodiments, one of the side laps 311 of the metal layer 310 of the second metal roofing shingle 302 overlays and is in electrical contact with the side lap 311 of the metal layer 310 of the first metal roofing shingle 301, to form a first grounding path. In some embodiments, the first grounding path is between metal roofing shingles 300 installed in the same row on the roof deck 400. In some embodiments, as the figure also shows, the third metal roofing shingle 303 is in electrical contact with the first metal roofing shingle 301, to form a second grounding path. In some embodiments, the first grounding path and the second grounding path are in electrical connection, thereby grounding the first metal roofing shingle 301, the second metal roofing shingle 302, and the third metal roofing shingle 303.

As FIG. 1 shows, in some embodiments, the roofing system 100 includes the plurality of fasteners 500. In some embodiments, the plurality of fasteners 500 includes at least a first fastener 501 and a second fastener 502. In some embodiments, the first fastener 501 penetrates each of the metal layer 310 of the first metal roofing shingle 301, the metal layer 310 of the second metal roofing shingle 302, and the roof deck 400. In some embodiments, the second fastener 502 penetrates each of the metal layer 310 of the first metal roofing shingle 301, the metal layer 310 of the third metal roofing shingle 303, and the roof deck 400. In some embodiments, one or more of the fasteners 500, such as but not limited to the first fastener 501 and/or the second fastener 502, form one or more portions of one or more grounding paths between the metal roofing shingles 300. In some embodiments, one or more fasteners 500 penetrate the side laps 311 of the metal roofing shingles 300.

As shown in FIGS. 1-3, in some embodiments, the metal roofing shingle 300 includes an adhesive 330. In some embodiments, the fastener 500 penetrates the adhesive 330 of the metal roofing shingle 300. In some embodiments, the adhesive 330 at least partially seals the hole formed in the metal roofing shingle 300 by the fastener 500. In some embodiments, the adhesive 330 includes a butyl adhesive. In some embodiments, the metal roofing shingle 300 includes a tab 315. In some embodiments, the tab 315 is a part of the metal layer 310, and includes the conductive metal material of the metal layer 310. In some embodiments, the tab 315 forms a portion of a grounding path between metal roofing shingles 300. In some embodiments, one or more of the adhesives 330 are on top or bottom surfaces of the tab 315, as FIG. 3 shows. In some embodiments, one of more of the fasteners 500 penetrate the tab 315 of the metal roofing shingle 300 when the metal roofing shingle 300 is installed on the roof deck 400.

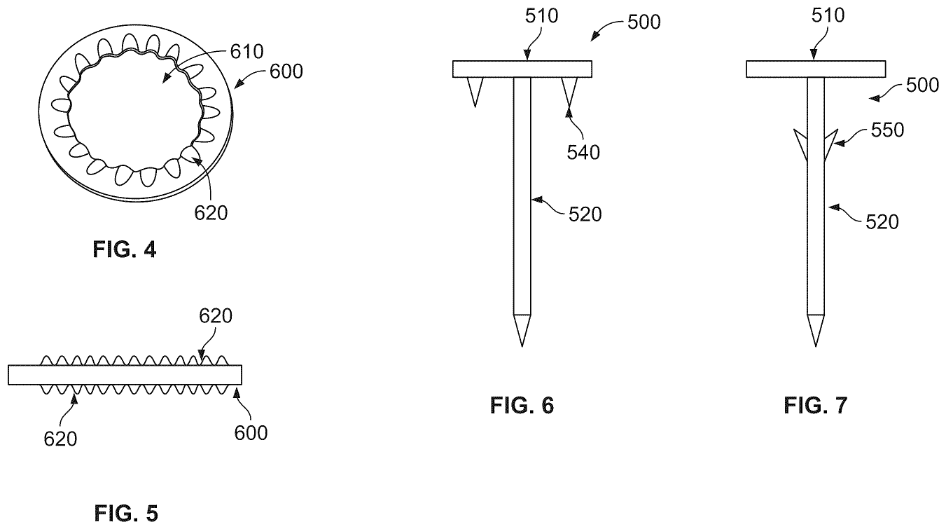

FIG. 4 is a schematic top view of a washer 600 of the roofing system 100, and FIG. 5 is a schematic side view of the washer 600 of FIG. 4, in accordance with some embodiments of the invention. In some embodiments, the roofing system 100 includes a plurality of washers 600. In some embodiments, the washers 600 include electrically conductive materials. In some embodiments, as FIG. 4 shows, the washers 600 include through holes 610. In some embodiments, a first one of the washers 600 is positioned between the metal layer 310 of the first metal roofing shingle 301, and the metal layer 310 of the second metal roofing shingle 302. In some embodiments, the first fastener 501 extends through the through hole 610 of the first one of the washers 600. In some embodiments, the second one of the washers 600 is positioned between the metal layer 310 of the first metal roofing shingle 301, and the metal layer 310 of the third metal roofing shingle 303, and the second fastener 502 extends through the through hole 610 of the second one of the washers 600. In some embodiments, the washers 600 form one or more portions of one or more grounding paths between the metal roofing shingles 300.

In some embodiments, as FIGS. 4 and 5 show, the washers 600 includes one or more corrugations 620, such as corrugated top and/or bottom surfaces. In some embodiments, the washers 600 are disposed between the metal roofing shingles 300, such that the corrugations 620 of the washers 600 are in contact with the metal layers 310 of the metal roofing shingles 300. Thus, for example, in some embodiments, the top surface of the washer 600 is in contact with a bottom surface of the metal roofing shingle 300, and, in some embodiments, the bottom surface of the washer 600 is in contact with the top surface of another metal roofing shingle 300. In some embodiments, the corrugations 620 of the first one of the washers 600 are in contact with the metal layer 310 of the first metal roofing shingle 301 and the metal layer 310 of the second metal roofing shingle 302. In some embodiments, corrugations 620 of the second one of the washers 600 are in contact with the metal layer 310 of the first metal roofing shingle 301 and the metal layer 310 of the third metal roofing shingle 303. In some embodiments, the corrugations 620 extend through any oxidation on surfaces of the metal layers 310 of the metal roofing shingles 300 and thus contact an unoxidized, electrically-conductive material of the metal layer 310, such that the corrugations 620 and the washers 600 form one or more portions of one or more grounding paths between the metal roofing shingles 300.

In some embodiments, one or more of the upper and lower surfaces of the washers 600 omits the corrugations 620. In some embodiments, one or more of the surfaces of the washers 600 includes a greater or lesser number of the corrugations 620 than shown. In some embodiments, one or more of the corrugations 620 has a different shape than shown.

FIG. 6 is a schematic side view of one of the fasteners 500, in accordance with some embodiment of the invention. As FIG. 6 shows, in some embodiments, the fastener 500 includes a fastener head 510, a fastener shaft 520 extending from the fastener head 510, and one or more than one fastener barb 540 extending from the underside of the fastener head 510. In some embodiments, when the fasteners 500 including the fastener barbs 540 are used to install the metal roofing shingles 300 on the roof deck 400, the fastener barbs 540 extend through the metal layers 310 of the metal roofing shingle 300. Thus, in some embodiments, when the first fastener 501 is the embodiment shown in FIG. 6, the fastener shaft 520 of the first fastener 501 penetrates each of the metal layer 310 of the first metal roofing shingle 301, the metal layer 310 of the second metal roofing shingle 302, and the roof deck 400; and the one or more than one fastener barb 540 of the first fastener 501 penetrates the metal layer 310 of the first metal roofing shingle 301, and the metal layer 310 of the second metal roofing shingle 302. In some embodiments, when the second fastener 502 is the embodiment shown in FIG. 6, the fastener shaft 520 of the second fastener 502 penetrates each of the metal layer 310 of the first metal roofing shingle 301, the metal layer 310 of the third metal roofing shingle 303, and the roof deck 400; and the one or more than one fastener barb 540 of the second fastener 502 penetrates the metal layer 310 of the first metal roofing shingle 301, and the metal layer 310 of the third metal roofing shingle 303. In some embodiments, the fastener barbs 540 further secure the metal roofing shingles 300 to one another and/or to the roof deck 400. In some embodiments, the fastener barbs 540 form one or more portions of one or more grounding paths between the metal roofing shingles 300. In some embodiments, fastener barbs 540 extend through the metal layers 310 of the metal roofing shingles 300 without extending into the roof deck 400.

FIG. 7 is a schematic side view of one of the fasteners 500, in accordance with some embodiment of the invention. As FIG. 7 shows, in some embodiments, the fastener 500 includes a fastener head 510, a fastener shaft 520 extending from the fastener head 510, and one or more than one fastener barb 550 extending from the outer surface of the fastener shaft 520. In some embodiments, when the fasteners 500 including the fastener barbs 550 are used to install the metal roofing shingles 300 on the roof deck 400, the fastener barbs 550 urge, push, or retain the metal layers 310 of the metal roofing shingle 300 into contact with one another. Thus, in some embodiments, when the first fastener 501 is the embodiment shown in FIG. 6, the fastener shaft 520 of the first fastener 501 penetrates each of the metal layer 310 of the first metal roofing shingle 301, the metal layer 310 of the second metal roofing shingle 302, and the roof deck 400. In some embodiments, the one or the more than one fastener barb 550 of the first fastener 501 retains the metal layer 310 of the first metal roofing shingle 301 in contact with the metal layer 310 of the second metal roofing shingle 302. In some embodiments, the one or the more than one fastener barb 550 of the first fastener 501 urges, pushes, or retains the metal layer 310 of the first metal roofing shingle 301 toward and/or in contact with the metal layer 310 of the second metal roofing shingle 302. In some embodiments, when the second fastener 502 is the embodiment shown in FIG. 6, the fastener shaft 520 of the second fastener 502 penetrates each of the metal layer 310 of the first metal roofing shingle 301, the metal layer 310 of the third metal roofing shingle 303, and the roof deck 400. In some embodiments, the one or the more than one fastener barb 550 of the second fastener 502 urges, pushes, or retains the metal layer 310 of the first metal roofing shingle 301 toward and/or in contact with the metal layer 310 of the third metal roofing shingle 303.

In some embodiments, one or more of the fasteners 500 omits the fastener barbs 540 and/or the fastener barbs 550. In some embodiments, one or more of the fasteners 500 includes a greater or lesser number of the fastener barbs 540 and/or the fastener barbs 550 than shown. In some embodiments, one or more of the fastener barbs 540 and/or the fastener barbs 550 has a different shape than shown. In some embodiments, one or more of the fasteners 500 includes one or more of the fastener barbs 540 and one or more of the fastener barbs 550.

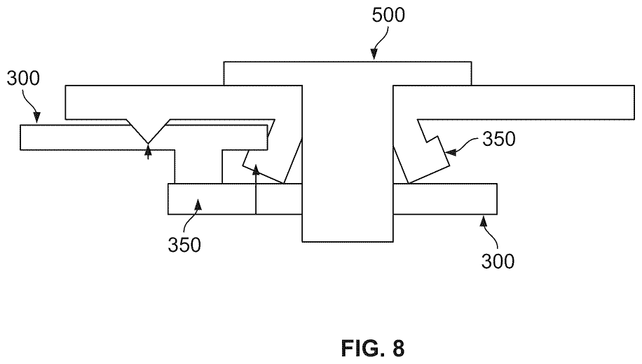

FIG. 8 is a schematic cross-sectional view of portions of the metal roofing shingles 300, in accordance with some embodiments of the invention. As FIG. 8 shows, in some embodiments, the metal roofing shingles 300 include one or more cooperating features 350. In some embodiments, the fastener 500 extends through the cooperating feature 350 in two metal roofing shingles 300, such that the cooperating features 350 are brought into engagement with one another and thereby securing the metal roofing shingles 300 to one another. Thus, in some embodiments, the fastener 501 extends through the cooperating feature 350 of the first metal roofing shingle 301, and the cooperating feature 350 of the second metal roofing shingle 302, so that the cooperating feature 350 of the first metal roofing shingle 301 is engaged with the cooperating feature 350 of the second metal roofing shingle 302. In some embodiments, the cooperating features 350 form one or more portions of one or more grounding paths between the metal roofing shingles 300.

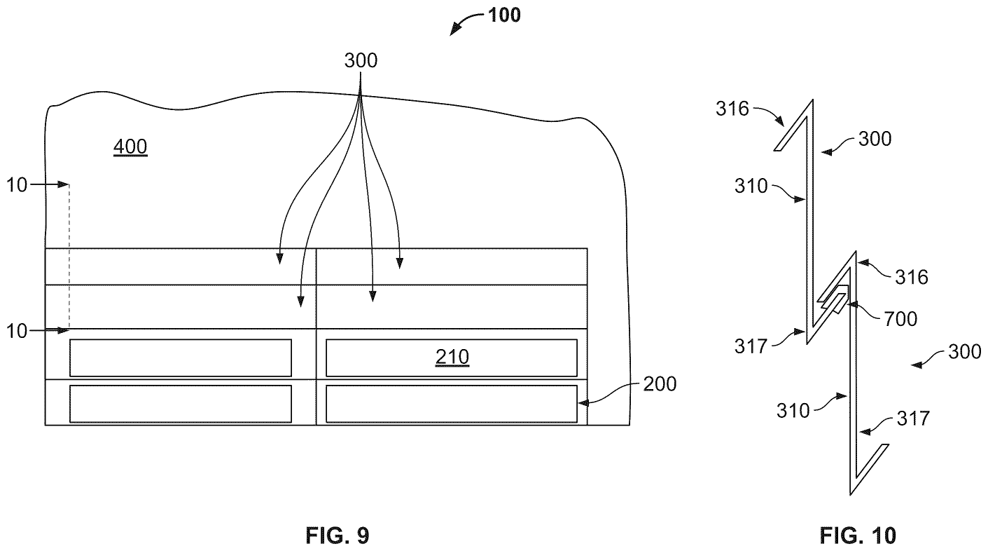

FIG. 9 is a schematic top view of the roofing system 100 including the plurality of photovoltaic modules 200 as well as the plurality of metal roofing shingles 300 installed on the roof deck 400, and FIG. 10 is a schematic cross-sectional view of the metal roofing shingle 300 taken along line X-X in FIG. 9, in accordance with some embodiments of the invention. In some embodiments, as FIG. 9 shows, the plurality of metal roofing shingles 300 are installed on the roof deck 400 adjacent to the plurality of photovoltaic modules 200. Although FIG. 9 shows the photovoltaic modules 200 and the metal roofing shingles 300 installed in rectangular arrays, in some embodiments, either or both of the photovoltaic modules 200 and/or the metal roofing shingles 300 are installed in an offset/staggered configuration, in which joints or seams between adjacent photovoltaic modules 200 and/or metal roofing shingles 300 in the same row are not aligned with the joints or seams between adjacent between adjacent photovoltaic modules 200 and/or metal roofing shingles 300 in the row that is directly above or directly below that row on the roof deck 400.

In some embodiments, the metal roofing shingle 300 includes the metal layer 310. As FIGS. 9 and 10 show, in some embodiments, the metal layer 310 includes an upper bend 316 and a lower bend 317. As FIG. 10 shows, in some embodiments, the upper bend 316 of the metal roofing shingle 300 in a lower row on the roof deck 400 is positioned within the lower bend 317 of the metal roofing shingle 300 in a higher row on the roof deck 400. In some embodiments, the roofing system 100 includes one or more than one clip 700 disposed between the upper bend 316 of the metal roofing shingle 300 in the lower row and the lower bend 317 of the metal roofing shingle 300 in the higher row. In some embodiments, the clip 700 includes a metal material. In some embodiments, the metal material is a conductive metal. In some embodiments, the clip 700 forms one or more portions of one or more grounding paths between the metal roofing shingles 300.

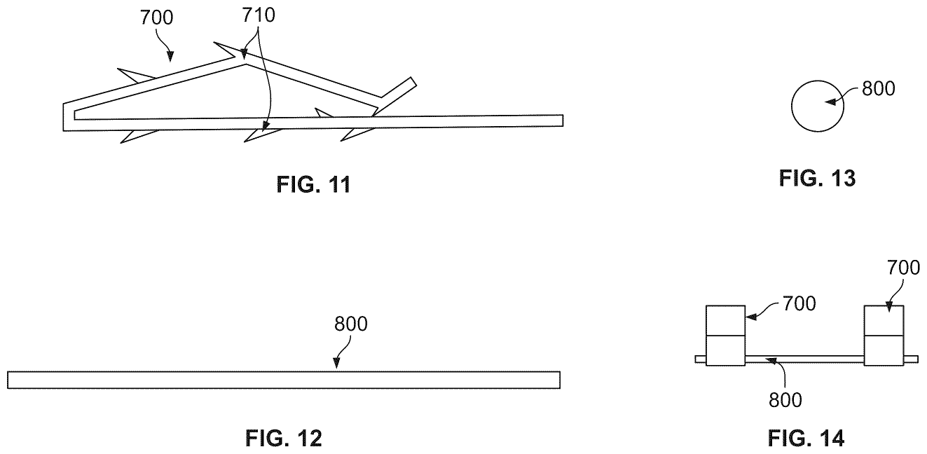

FIG. 11 is a schematic cross-sectional view of the clip 700, in accordance with some embodiments of the invention. As FIG. 11 shows, in some embodiments, the clips 700 includes one or more protrusions 710. In some embodiments, the protrusions are in contact with the upper bend 316 and/or the lower bend 317 of the metal roofing shingle 300. Thus, in some embodiments, the protrusions 710 retain the clip 700 in its position, retain the clip 700 in contact with the upper bend 316 and/or the lower bend 317, and/or form one or more portions of one or more grounding paths between the metal roofing shingles 300. In some embodiments, one or more of the surfaces of the clips 700 omit the protrusions 710. In some embodiments, one or more of the surfaces of the clips 700 include a greater or lesser number of the protrusions 710 than shown. In some embodiments, one or more of the protrusions 710 has a different shape than shown.

FIG. 12 is a schematic top view of a connector 800, and FIG. 13 is a schematic side view of the connector 800, and FIG. 14 is a schematic top view of two clips 700 connected by connector 800, in accordance with some embodiments of the invention. As FIGS. 12-14 show, in some embodiments, the connector 800 is a bar. In some embodiments, the connector 800 is a conductive material. In some embodiments, the connector 800 connects clips 700 within a same row on the roof deck 400. In some embodiments, the roofing system 100 includes a plurality of connectors 800 connecting clips 700 to one another. Thus, in some embodiments, the clips 700 are installed in different ones of the metal roofing shingles 300 that are installed in the same row on the roof deck 400, and the connector 800 forms one or more portions of one or more grounding paths between the metal roofing shingles 300 in the same row on the roof deck 400.

Variations, modifications, and alterations to embodiments of the present disclosure described above will make themselves apparent to those skilled in the art. All such variations, modifications, alterations and the like are intended to fall within the spirit and scope of the present disclosure. While several embodiments of the present disclosure have been described, it is understood that these embodiments are illustrative only, and not restrictive, and that many modifications may become apparent to those of ordinary skill in the art. Any feature or element that is positively identified in this description may also be specifically excluded as a feature or element of an embodiment of the present. The disclosure described herein may be practiced in the absence of any element or elements, limitation or limitations, which is not specifically disclosed herein. The terms and expressions which have been employed are used as terms of description and not of limitation, and there is no intention in the use of such terms and expressions of excluding any equivalents of the features shown and described or portions thereof, but it is recognized that various modifications are possible within the scope of the disclosure.

What is claimed is:

1. A roofing system, comprising:
a roof deck;
a plurality of photovoltaic modules installed on the roof deck,
wherein each of the plurality of photovoltaic modules includes at least one solar cell; and
a plurality of metal roofing shingles installed on the roof deck adjacent to the plurality of photovoltaic modules,
wherein the plurality of metal roofing shingles includes at least a first metal roofing shingle, a second metal roofing shingle, and a third metal roofing shingle,
wherein the first metal roofing shingle and the second metal roofing shingle are installed in a first row on the roof deck,
wherein the third metal roofing shingle is installed in a second row on the roof deck,
wherein the second row is adjacent the first row on the roof deck,
wherein each of the plurality of metal roofing shingles includes a metal layer,
wherein the metal layer includes a conductive metal,
wherein the metal layer includes a side lap,
wherein the side lap of the metal layer of the second metal roofing shingle overlays and is in electrical contact with the side lap of the metal layer of the first metal roofing shingle, to form a first grounding path,
wherein the third metal roofing shingle is in electrical contact with the first metal roofing shingle, to form a second grounding path.

2. The roofing system of claim 1, wherein the first grounding path and the second grounding path are in electrical connection.

3. The roofing system of claim 1, further comprising:
a plurality of fasteners,
wherein the plurality of fasteners includes at least a first fastener and a second fastener,
wherein the first fastener penetrates each of:
the metal layer of the first metal roofing shingle,
the metal layer of the second metal roofing shingle, and
the roof deck,
wherein the second fastener penetrates each of:
the metal layer of the first metal roofing shingle,
the metal layer of the third metal roofing shingle, and
the roof deck.

4. The roofing system of claim 3, further comprising:
a plurality of washers,
wherein each of the plurality of washers includes a through hole,
wherein the plurality of washers includes at least a first washer and a second washer,
wherein the first washer is positioned between:
the metal layer of the first metal roofing shingle, and
the metal layer of the second metal roofing shingle,
wherein the first fastener extends through the through hole of the first washer,
wherein the second washer is positioned between:
the metal layer of the first metal roofing shingle, and
the metal layer of the third metal roofing shingle,
wherein the second fastener extends through the through hole of the second washer.

5. The roofing system of claim 4, wherein each of the plurality of washers includes corrugations, wherein the corrugations of the first washer are in contact with the metal layer of the first metal roofing shingle and the metal layer of the second metal roofing shingle, wherein the corrugations of the second washer are in contact with the metal layer of the first metal roofing shingle and the metal layer of the third metal roofing shingle.

6. The roofing system of claim 1, further comprising:
a plurality of fasteners,
wherein the plurality of fasteners includes at least a first fastener, a second fastener, and a third fastener,
wherein each of the plurality of fasteners includes:
a fastener head,
a fastener shaft extending from the fastener head, and
at least one fastener barb extending from the fastener head,
wherein the fastener shaft of the first fastener penetrates each of:
the metal layer of the first metal roofing shingle,
the metal layer of the second metal roofing shingle, and
the roof deck,
wherein the at least one fastener barb of the first fastener penetrates:
the metal layer of the first metal roofing shingle, and
the metal layer of the second metal roofing shingle,
wherein the fastener shaft of the second fastener penetrates each of:
the metal layer of the first metal roofing shingle,
the metal layer of the third metal roofing shingle, and
the roof deck,
wherein the at least one fastener barb of the second fastener penetrates:
the metal layer of the first metal roofing shingle, and
the metal layer of the third metal roofing shingle.

7. The roofing system of claim 1, further comprising:
a plurality of fasteners,
wherein the plurality of fasteners includes at least a first fastener, a second fastener, and a third fastener,
wherein each of the plurality of fasteners includes:
a fastener head,
a fastener shaft extending from the fastener head, and
at least one fastener barb extending from the fastener shaft,
wherein the fastener shaft of the first fastener penetrates each of:
the metal layer of the first metal roofing shingle,
the metal layer of the second metal roofing shingle, and
the roof deck,
wherein the at least one fastener barb of the first fastener retains the metal layer of the first metal roofing shingle in contact with the metal layer of the second metal roofing shingle,
wherein the fastener shaft of the second fastener penetrates each of:
the metal layer of the first metal roofing shingle,
the metal layer of the third metal roofing shingle, and
the roof deck,
wherein the at least one fastener barb of the second fastener retains the metal layer of the first metal roofing shingle in contact with the metal layer of the third metal roofing shingle.

8. The roofing system of claim 1, further comprising:
a plurality of fasteners,
wherein the plurality of fasteners includes at least a first fastener,
wherein each of the plurality of metal roofing shingles comprise at least one cooperating feature,
wherein the first fastener extends through:
the at least one cooperating feature of the first metal roofing shingle, and
the at least one cooperating feature of the second metal roofing shingle, so that the at least one cooperating feature of the first metal roofing shingle is engaged with the at least one cooperating feature of the second metal roofing shingle.

9. The roofing system of claim 1, wherein each of the plurality of metal roofing shingles includes an adhesive, wherein the roofing system includes a fastener, wherein the fastener penetrates the adhesive of at least one of the first metal roofing shingle or the second metal roofing shingle.

10. A roofing system, comprising:
a roof deck;
a plurality of photovoltaic modules installed on the roof deck,
wherein each of the plurality of photovoltaic modules includes at least one solar cell;
a plurality of metal roofing shingles installed on the roof deck adjacent to the plurality of photovoltaic modules,
wherein the plurality of metal roofing shingles includes at least a first metal roofing shingle and a second metal roofing shingle,
wherein the first metal roofing shingle is installed in a first row on the roof deck,
wherein the second metal roofing shingle is installed in a second row on the roof deck,
wherein the second row is adjacent the first row on the roof deck,
wherein each of the plurality of metal roofing shingles includes a metal layer,
wherein the metal layer includes a conductive metal material,
wherein the metal layer includes an upper bend and a lower bend;
and
a plurality of clips,
wherein the plurality of clips includes at least a first clip,
wherein the first clip is in electrical contact with each of:
the upper bend of the first metal roofing shingle, and
the lower bend of the second metal roofing shingle,
to form a first grounding path.

11. The roofing system of claim 10, wherein each of the plurality of clips includes a first protrusion, wherein the first protrusion of the first clip is in contact with the upper bend of the first metal roofing shingle, and a second protrusion, wherein the second protrusion of the first clip is in contact with the lower bend of the second metal roofing shingle.

12. The roofing system of claim 10, wherein the plurality of metal roofing shingles further includes at least a third metal roofing shingle, wherein the plurality of clips further includes a second clip, wherein the roofing system further includes a connector, wherein the third metal roofing shingle is installed in the first row of the roof deck, adjacent to the first metal roofing shingle, wherein the second clip contacts the upper bend of the third metal roofing shingle, to form a second grounding path, wherein the connector is in connection with the first clip and the second clip, to form a third grounding path.

13. A method, comprising:
obtaining a photovoltaic module and a plurality of metal roofing shingles,
wherein each of the plurality of photovoltaic modules includes at least one solar cell,
wherein the plurality of metal roofing shingles includes at least a first metal roofing shingle, a second metal roofing shingle, and a third metal roofing shingle,
wherein each of the plurality of metal roofing shingles includes a metal layer,
wherein the metal layer includes a conductive metal material,
wherein the metal layer includes a side lap;
installing the photovoltaic module on a roof deck;
installing the first metal roofing shingle in a first row on the roof deck, adjacent to the photovoltaic module;
installing the second metal roofing shingle in the first row on the roof deck, adjacent to the first metal roofing shingle,
wherein the side lap of the metal layer of the second metal roofing shingle overlays and is in electrical contact with the side lap of the metal layer of the first metal roofing shingle, to form a first grounding path; and
installing the third metal roofing shingle in a second row on the roof deck,
wherein the second row is adjacent the first row on the roof deck,
wherein the third metal roofing shingle is in electrical contact with the first metal roofing shingle, to form a second grounding path.

14. The method of claim 13, wherein the first grounding path is in electrical connection with the second grounding path.

15. The method of claim 13, wherein the installing the first metal roofing shingle includes penetrating, with a first fastener, each of the metal layer of the first metal roofing shingle, the metal layer of the second metal roofing shingle, and the roof deck.

16. The method of claim 13, further comprising obtaining a washer, wherein the washer includes a through hole, wherein the installing the second metal roofing shingle includes positioning a washer between the metal layer of the first metal roofing shingle, and the metal layer of the second metal roofing shingle; and disposing a fastener through each of the metal layer of the first metal roofing shingle, the metal layer of the second metal roofing shingle, the through hole of the washer, and the roof deck.

17. The method of claim 13, further comprising obtaining a fastener, wherein the fastener includes a fastener head, a fastener shaft extending from the fastener head, and at least one fastener barb extending from the fastener head; wherein the installing the second metal roofing shingle includes penetrating, with the fastener shaft of the fastener, each of the metal layer of the first metal roofing shingle, the metal layer of the second metal roofing shingle, and the roof deck; and penetrating, with the at least one fastener barb of the fastener, each of the metal layer of the first metal roofing shingle, and the metal layer of the second metal roofing shingle.

18. The method of claim 13, further comprising obtaining a fastener, wherein the fastener includes a fastener head, a fastener shaft extending from the fastener head, and at least one fastener barb extending from the fastener shaft; wherein the installing the second metal roofing shingle includes penetrating, with the fastener shaft of the fastener, each of the metal layer of the first metal roofing shingle, the metal layer of the second metal roofing shingle, and the roof deck; and urging toward one another, with the at least one fastener barb of the fastener, each of the metal layer of the first metal roofing shingle, and the metal layer of the second metal roofing shingle.

19. The method of claim 13, further comprising obtaining a fastener, wherein the fastener includes a fastener head, a fastener shaft extending from the fastener head, and at least one fastener barb extending from the fastener shaft; wherein the installing the second metal roofing shingle includes penetrating, with the fastener shaft of the fastener, each of the metal layer of the first metal roofing shingle, the metal layer of the second metal roofing shingle, and the roof deck; and urging toward one another, with the at least one fastener barb of the fastener, each of the metal layer of the first metal roofing shingle, and the metal layer of the second metal roofing shingle.

20. The method of claim 13, wherein each of the plurality of metal roofing shingles includes at least one cooperating feature, wherein the installing the second metal roofing shingle includes installing a fastener through each of the at least one cooperating feature of the first metal roofing shingle, and the at least one cooperating feature of the second metal roofing shingle, so that the at least one cooperating feature of the first metal roofing shingle is engaged with a corresponding at least one cooperating feature of the second metal roofing shingle.
